(19) United States
(12) Patent Application Publication
(10) Pub. No.: US 2007/0107036 A1
(43) Pub. Date: May 10, 2007

(54) Method and system for broadcasting digital programs

(75) Inventors: Ningjiang Chen, Shanghai (CN); Fons Bruls, Eindhoven (NL); Yongqin Zeng, Shanghai (CN); Xin Chen, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/580,499

(22) PCT Filed: Nov. 25, 2004
(86) PCT No.: PCT/IB04/52542

§ 371 Date: May 23, 2006

(30) Foreign Application Priority Data
Nov. 28, 2003 (CN) 200310119991.7

(51) Int. Cl. H04N 7/16

(52) U.S. Cl. 725/135; 725/138

(57) ABSTRACT

This invention provides a method that when the disturbance of the bandwidth or the signal quality occurs during the digital program broadcasting, so that the broadcasting quality of the currently broadcast normal program is below a predetermined value, a prearranged program having a specific broadcasting quality, such as advertisements, will be inserted. The prearranged program may have an regular relation to the currently broadcast normal program, thereby the user would rather appreciate some program than suffer bad screen showing or wait until the program returns back to a good condition to be watched normally. This invention further provides a method for making statistics of the inserted prearranged program, said statistical information could be used for charging.

### BACKGROUND OF THE INVENTION

The present invention relates to a method and system for broadcasting digital programs and particularly, to a method/system for IP broadcasting and a method/system for terrestrial digital video broadcasting (DVB-T).

The MPEG-2 (Motion Picture Experts Group) standard (ISO/IEC 131818-1) is a relatively widespread standard used in digital video broadcasting recently. That standard is a standard for providing digital data stream to digital devices such as set top box (STB), digital television (DTV), interactive digital television (iDTV), personal computer, hand-held devices, and other interactive devices, etc.

The MPEG-2 over IP is a method of packetizing data streams conforming with the MPEG-2standard into packets such as the TCP/IP (Transmission Control Protocol/Internet Protocol) packets or UDP (User Datagram Protocol)/IP packets and transmitting them over the Internet. That method is a preferable method of IP broadcasting .

In the near future, digital television broadcast via broadband Internet will become a reality and widespread, this will provide a new entertainment service for the users, and this will also provide a new opportunity for offering value-added services for the service providers. However, since the quality of service (QoS) of the network can not be always guaranteed, e.g., the network bandwidth variations which will result in temporary interrupts of broadcasting, causing still pictures or variable and fuzzy pictures or even no contents at all on the user interface such as the TV screen, thus giving unpleasant impressions to the users.

Furthermore, during the broadcasting of the existing terrestrial digital television program, broadcasting signal quality variations may occur in a certain time period at certain areas, especially for the moving users, the signal quality variation will be more significant due to the effect of moving velocity or the masking of buildings, thus the temporary interrupts of broadcasting, still pictures or variable and fuzzy pictures or even no contents on the user interface, such as the TV screen may also occur, giving unpleasant impressions to the users.

Therefore, there is a need for a method and system of new digital video broadcasting which can, at least, ensure the user to watch certain programs during the occurrence of network variations or signal quality variations.

### SUMMARY OF THE INVENTION

The present invention provides (a method for) interposing a prearranged program, such as advertisement, of specific broadcasting quality when the broadcasting quality of the currently broadcasting normal program is below a predetermined value due to the occurrence of bandwidth variation or signal quality variation, wherein the prearranged program may have certain association with the currently broadcasting program, thereby the user may watch some programs without enduring the vibrating and fuzzy pictures or just waiting the normal program to resume watchable level.

For IP broadcasting, said prearranged program may come from a local server which has a specific broadcasting service quality, or a local storage. The prearranged program stored in the local storage may be stored in advance prior to the broadcasting of the normal program to be broadcast, or may be another program attached to the normal program which is stored during the broadcasting of the normal program, or may be downloaded from the network broadcast server or the local server when spare network bandwidth is available during the broadcasting of the normal program. Furthermore, the present invention can reacquire the lost segments of the normal program and connect them to the succeeding program to relieve the user from suffering bandwidth variation.

As for terrestrial digital video broadcasting, said prearranged program comes from a local storage, the prearranged program stored in the local storage can be stored in advance prior to the broadcasting of the normal program to be broadcast, it can also be another program attached to the normal program stored during the broadcasting of the normal program.

The present invention further provides a method of collecting statistics of the interposeed prearranged program, and relevant parties are charged by the broadcasting service provider according to the statistical information.

The present invention has not only resolved the problem that no program can be watched or only variable and fuzzy pictures can be watched by the user during the occurrence of network variation or signal quality variation, but also has made relevant value-added service provided by the broadcasting service provider technically possible.

Other objects and achievements of the present invention will be obvious and a more comprehensive understanding of the present invention will be attained with reference to the following description made in association with the accompanying figures and the claims.

### BRIEF DESCRIPTION OF THE DRAWINGS

The present invention will be explained in detail in the form of embodiments and with reference to the accompanying figures, wherein:

FIG. 1 is a schematic diagram showing a system for interposing prearranged programs during network digital broadcasting according to an embodiment of the present invention;

FIG. 2 is a schematic flowchart of interposing prearranged programs during network digital broadcasting according to an embodiment of the present invention;

FIG. 3 is a schematic diagram showing the network service quality variations during network digital broadcasting according to an embodiment of the present invent ion;

FIG. 4 is a schematic flowchart of connecting the lost normal program to its succeeding program during network digital broadcasting according to an embodiment of the present invention;

FIG. 5 is a schematic diagram showing a system for interposing prearranged programs during terrestrial digital broadcasting according to another embodiment of the present invention; and

FIG. 6 is a schematic flowchart of interposing prearranged programs during terrestrial digital broadcasting according to yet another embodiment of the present invention.

Like reference signs denote similar or same features and functions throughout the accompanying figures.

### DETAILED DESCRIPTION OF THE PREFERRED EMBODIMENTS

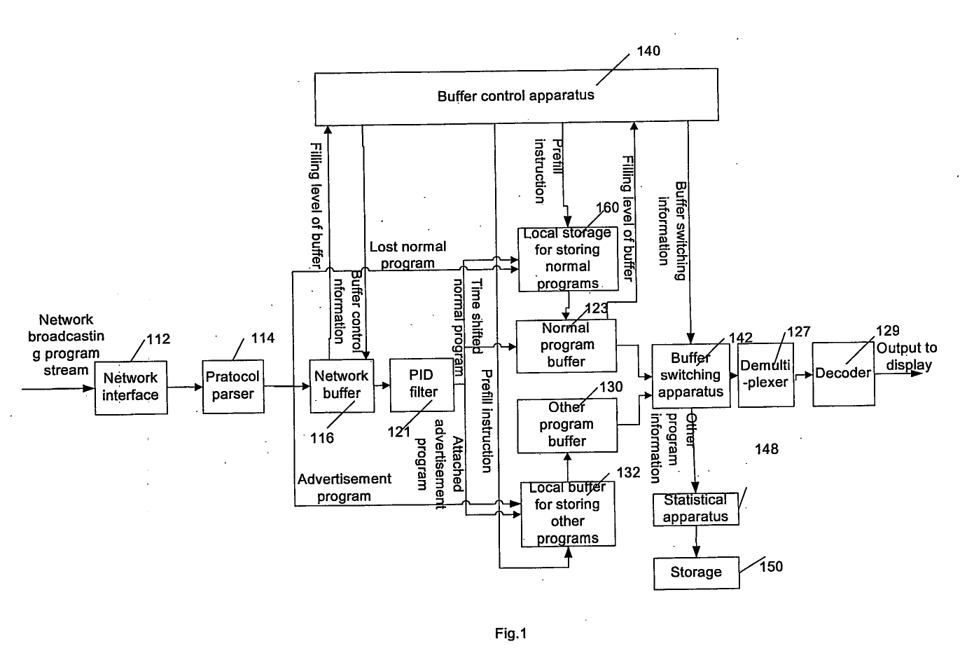

FIG. 1 is a schematic diagram showing a system for interposing prearranged programs during network digital broadcasting according to an embodiment of the present invention. In addition to a program broadcasting apparatus as included in an existing broadcasting system, that digital video broadcasting system further comprises a detecting apparatus for detecting the broadcasting quality of the currently broadcasting normal program, and a switching apparatus for interposing a prearranged program, i.e. another program when the detected broadcasting quality is below a predetermined value, wherein the broadcasting quality of the another program is above the level acceptable by the user, that is, it reaches a predetermined level. The program broadcasting apparatus normally further comprises a network interface 112, a protocol parser 114, a network buffer 116, a PID filter 121, a normal program buffer 123, a demultiplexer 127 and a decoder 129.

Firstly, a network digital broadcasting program stream is downloaded to the local area of the user via the network interface 112, if the broadcasting program provides opportunity of interaction with the local user, the program stream is normally composed of UDP/IP packets; if the broadcasting program does not provide opportunity of interaction with the local user, the program steam is normally composed of TCP/IP packets. The broadcasting program stream, after being processed by the protocol parser 114 to remove the IP packet header and the UDP or TCP packet header, becomes a program transmission stream conforming with the MPEG-2standard and is sent to the network buffer 116.

If the program transmission stream is a multi-program transmission stream, transmission stream of the program selected according to the program selection information of the user is sent to the normal program buffer 123 via a PID (Packet Identifier) filter 121, the selected program transmission stream is further sent to a demultiplexer 127 via a buffer switching means 142 to be demultiplexed into a PES (Packetized Element Stream), finally the PES is decoded by a decoder 129 into an audio/video signal output to the display. Since the user controller for selecting programs by the user and the conditional access controller for controlling the access of programs by a user in said digital video broadcasting system are not the focal points of the present invention, they are not described in detail here and not shown in relevant figures.

Phenomena of loss of packets and late arrival of program packets occur when bandwidth variation of the network appears, especially when the service quality of the network degrades to a predetermined value, the packets arrived latter are discarded by the network buffer according to their PCR (Program Clock Reference) values. Since it is impossible to perform Correctly the subsequent process, such as decoding of the latter arrived packets, the filling level of the normal program buffer is greatly lowered, thereby, still pictures or variable pictures appear.

Meanwhile the present embodiment determines that the normal program can not be broadcast with guaranteed quality based on the filling level of the normal program buffer 123, this determination is made by a detecting apparatus, such as the buffer control apparatus 140. Then, the buffer control apparatus 140 sends a switching information to a switching apparatus such as the buffer switching apparatus 142 which connects another program buffer 130 to the demultiplexer 127. The another program buffer 130 may acquire other program streams such as advertisement program stream from a local storage 132 for storing other programs to replace the normal program stream, sends it to the demultiplexer to be processed and finally to be presented to the user.

At the same time with the interposing of another program, the normal program stream can still be filled into the normal program buffer 123 through the network buffer 116 and the PID filter 121, and its filling level is detected by the buffer control apparatus 140. When the filling level of the normal program buffer restores to a predetermined value, it indicates that the available broadcasting quality of the normal program has restored to the level acceptable by the user. Meanwhile the buffer control apparatus 140 sends a switching information to the buffer switching apparatus 142 which switches back the demultiplexer 127 to the status of connecting the normal program buffer 123 again, thus to resume broadcasting the normal program. The switching flow will be detailed in the following.

The present embodiment further provides a time shift function for the normal program. This function may acquire the lost segments of the normal program during interposing other programs, and connect those segments to the succeeding program for broadcasting, thereby the user may be ignorant of the bandwidth variation.

In order to implement the time shift function, the protocol parser 114 may send a request to the server (not shown in the figure) such as the network server broadcasting the normal program during the interposing of another program. This request includes the information about the lost segments of the normal program and requests the network server to transmit again the lost segments of the normal program, then the received lost segments of the normal program and their succeeding segments of the normal program are stored in order into a local storage 160 for storing the normal program. Those programs stored in the local storage are further sent to the normal program buffer 123. This time shift function will be detailed in the following.

The digital video broadcasting system of the present embodiment further comprises a statistical apparatus 148 for making statistics of the times and the content types of the interposeed other prearranged programs. This statistical apparatus can also be included in the buffer switching apparatus 142, and is capable of making statistics of the broadcasting information of other programs such as the content types of broadcasting, the time intervals of broadcasting and the like. Those information are stored in a local storage 150 in the form of a file, or they may be transmitted in real time to a network server such as a network broadcasting server via a network. The network broadcasting service provider may charge relevant parties based on the statistical information in the file, and if the contents of other programs are advertisements, the advertiser may be charged.

The statistical function may be implemented by the PID values of the transmission small packets of the other program stream. According to the specification of the MPEG-2 standard, besides a portion of the values are defined by the standard, there remains a segment of the value domain to be defined by the user. The mapping relationships between the type of the stream and PID are recorded in a program map table, where the values 0X80-0XFF of the stream types are to be defined by the users themselves. For example, the stream type 0X88 may be defined as advertisement type programs, the corresponding PID=0X30 may be defined as the program transmission stream of the advertiser A, thus, the statistical apparatus 148 may collect all the broadcasting information with PID=0X33 to be used to charge the advertiser A.

The local storage mentioned in the present invention may be a hard disk drive (HDD), an optical disk drive (CD or DVD), a magnetic tape drive or other types of magnetic/optical storages. The plurality of local storages mentioned in the present invention may be combined into one storage, provided that they can achieve the same functionality.

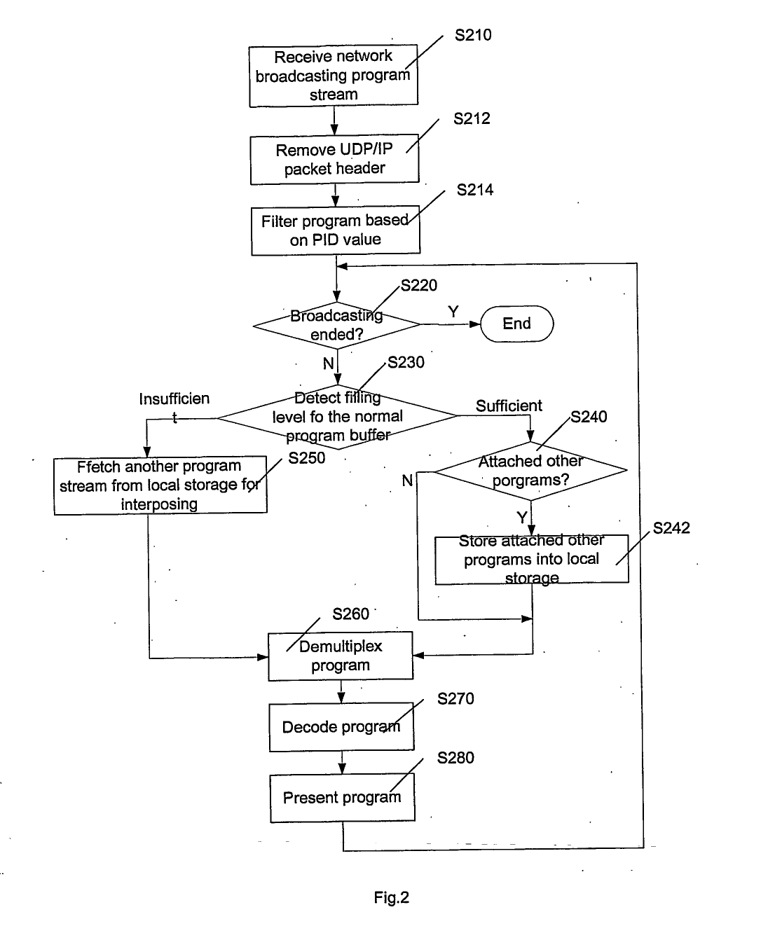

FIG. 2 is a schematic flowchart of interposing prearranged program during network digital broadcasting according to an embodiment of the present invention. This flow is a flow of switching the broadcasting between a normal program and a prearranged program, i.e. another program. Firstly, an network broadcasting program stream is received over the network (step S210), the IP packet header and the UDP packet header are removed (step S212) to make the program transmission stream conform to MPEG-2, then the PID value is filtered according to the choice of the user (step S214), every transmission small packet relevant to the program chosen by the user is selected for further processing.

Secondly, it is determined whether the broadcasting of the normal program is completed according to the IP broadcasting protocol (step S220), if not, the filling level of the normal program buffer is detected (step S230).

If the filling level of the normal program buffer is sufficient, for example >60%, the normal program is broadcast, and if the program being broadcast is another program attached to the normal program (step S240), then other attached program can be stored into a local storage at the same time with the broadcasting (step S242) for future interposing.

If the filling level of the normal program buffer is insufficient, that is, the buffer is underflow, another program stream is fetched from a local storage and interposeed for broadcasting (step S250). The broadcasting quality of another program stream may reach the predetermined standard to surely satisfy the requirement of the user, because this program stream is from the local area. Of course, if the local network is of specific service quality, that is the service quality thereof is guaranteed, another program stream for interposing can also be directly fetched from a local server.

There are three main sources of other program streams stored in the local storage:
1) Other program streams stored in advance in the local storage prior to the broadcasting of the normal program;
2) Other program streams acquired from a network server, especially a local area network server when spare bandwidth is available, and stored in the local storage during the broadcasting of the normal program;
3) Whether a segment is another program attached to the normal program can be determined by determining whether the PID value of a transmission small packet is a specific value during the broadcasting of the normal program (step S240), and another program stream is a portion of the normal program stream. If so, it is stored into a local storage and at the same time transferred for further processing (step S242); if not, it is directly transferred for further processing.

Finally, the normal program or other programs are demultiplexed (step S260) and further decoded (step S270), and subsequently it is presented to the user in certain form (step S280).

During the above mentioned switching procedure, because the program clock references of the normal program and the another program are different, it is necessary to adjust the program clock in the program switching procedure, and this adjustment method is specified by the MPEG-2standard. In order to achieve this object, the corresponding program clock references and transmitting code rates shall be stored while storing other programs into the local storage.

At the same time, in the above mentioned switching procedure, in order to broadcast surely a complete segment of the another program, the segments of the another program can be set to a fixed length, or specific labels can be interposeed into the other programs to indicate the segments that shall be broadcast (referring to US Patent Application Publication No. US 20020065678 A1, Publication Date: May 30, 2002, the disclosure of that application is incorporated herein by reference), a decision step is added between the step S220 and the step S230 for determining whether the another program is completely broadcast. If not, another program stream is fetched directly from the local storage without detecting the filling level of the normal program buffer, and if another program has been completely broadcast, then the filling level of the normal program buffer is further detected.

Other programs mentioned in the present invention may be advertisements associated with the program, for example, if movies of the “007” series are broadcasting, an advertisement segment played by the male leading role may be interposeed.

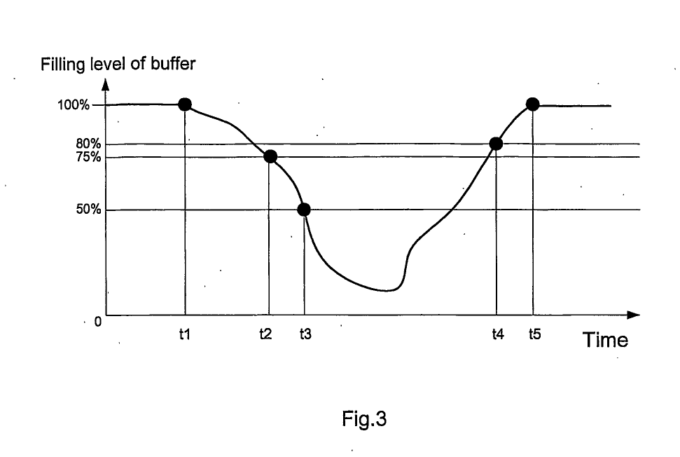

FIG. 3 is a schematic diagram showing the network service quality variations during the IP digital broadcasting according to an embodiment of the present invention. Before the time t1, the filling level of the normal program buffer 123 in FIG. 1 is 100%, indicating that the network is completely normal. In the period from t1 to t2, the filling level of the normal program buffer 123 falls from 100% to 75%, indicating that bandwidth variation begins to occur in the network and the network service quality begins to degrade but still meets the requirements of broadcasting.

Between time t2 and time t3, the filling level of the normal program buffer is decreased from 75% to 5%, indicating that the network service quality is worse but broadcasting can still continue, while once the filling level of the normal program buffer 123 becomes below a threshold 75%, the buffer control apparatus 140 in FIG. 1 issues an instruction to start to read a prearranged program, i.e. another program from the local storage 132 used for storing other programs to prefill the other program buffer 130. The object of doing so is that once the demultiplexer 127 in FIG. 1 is connected to the other program buffer 130 by the buffer switching apparatus 142, another program can be broadcast immediately.

Immediately after the time t3, the filling level of the normal program buffer has been decreased to less than the predetermined value 50%, indicating that the network service quality can not meet the requirement of broadcasting, therefore, the buffer control apparatus 140 issues an instruction at time t3 to connect the demultiplexer 127 to the other program buffer 130 by the buffer switching apparatus 142, where another program begins to be broadcast.

Before the time t4, that is, before the filling level of the normal program buffer 123 is increased to another predetermined value 80%, another program is interposeed all the time. When the filling level of the normal program buffer 123 is increased to 80%, that is, the network service quality has fully restored, and the available broadcasting quality has reached the requirement of broadcasting, then the buffer control apparatus 140 issues an instruction to connect the demultiplexer 127 to the normal program buffer 123 by the buffer switching apparatus 142, and the broadcasting of the normal program resumes. The reason that the requirement for the network service quality at switching back to the normal program broadcasting is higher than that at switching to the another program broadcasting is to ensure that the network service quality has been restored definitely rather than an occasional variation.

Of course, the service quality of the network can also be determined based on the filling level of the network buffer 116 at the exit of the network, especially when it is a single program broadcasting stream, the filling level of the network buffer 116 is substantially equal to that of the normal program buffer 123 in that case.

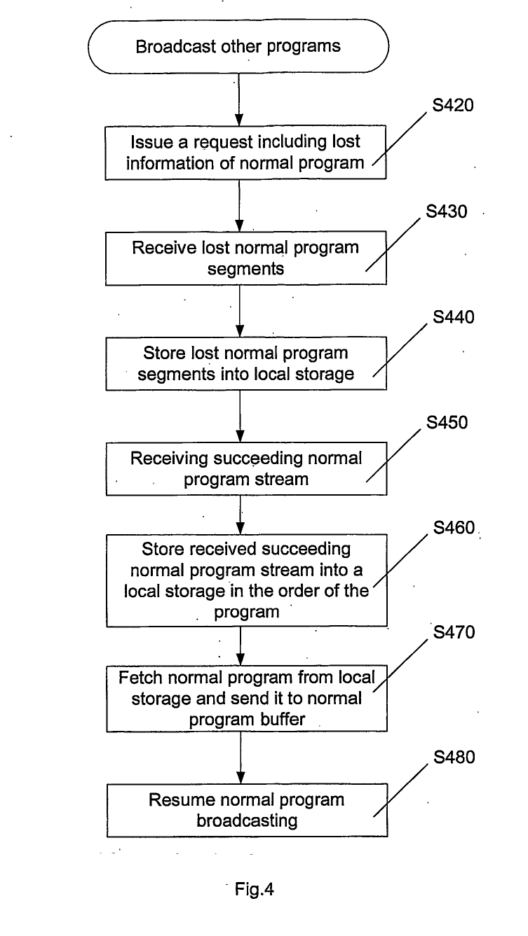

FIG. 4 is a schematic flowchart of connecting the lost normal program to its succeeding program during network digital broadcasting according to an embodiment of the present invention. This flow is a flow of the time shift of a normal program. Firstly, at the same time with interposing a prearranged program, i.e. another program, the protocol parser 114 in FIG. 1 issues to the network server a request including information about the loss of a normal program (step S420), this request includes the starting time and ending time of the lost normal program segment and etc. This request can be issued to the network broadcasting server currently broadcasting the normal program, and this network broadcasting server takes the priority of sending back the lost normal program stream when the network service quality restores. Alternatively, it is issued to a local server which can ensure the service quality, and the network broadcasting server currently broadcasting the normal program takes the priority to guarantee transmitting normal program stream to the local server when the bandwidth variations in the network occur.

When a lost normal program stream segment is received (step S430), it is directly stored in a local storage for storing normal programs after the IP and TCP packet headers are removed by the protocol parser (step S440). At the same time, the subsequent normal program stream is received (step S450), which is stored after the lost normal program stream segments in temporal order of the program after passing through the network buffer and the PID filter (step S460).

Finally, the normal program is read to the normal program buffer from the local storage for storing normal programs (step S470), once the filling level of the normal program buffer meets the requirement for switching back to broadcasting the normal program, the broadcasting of the normal program resumes immediately (step S480).

During this process, since another program is of fixed length, the remaining broadcasting time of another program can be predicted. The buffer control apparatus 140 in FIG. 1 may issue an instruction to read normal program stream from the local storage for storing the normal program to prefill the normal program buffer based on the remaining broadcasting time.

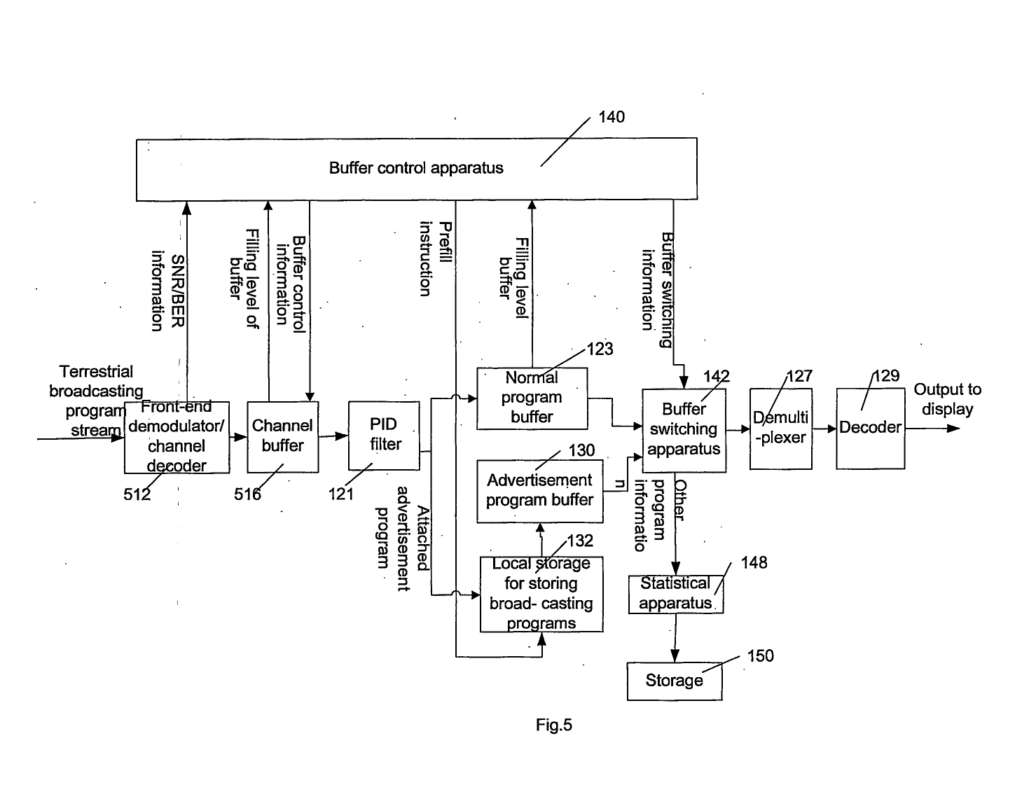

FIG. 5 is a schematic diagram showing a system for interposing prearranged program during terrestrial digital broadcasting according to another embodiment of the present invention. This system is substantially the same as that shown in FIG. 1, only that the signal sources are different, hence there are some differences on the program receiving means, for example, the network interface 112, protocol parser 114 and network buffer 116 are replaced by a front-end decoder/channel decoder 512 and a channel buffer 516; at the same time, this system does not have the time shift functionality. The similar parts are no more described, only those different parts are described in the following.

A terrestrial digital broadcasting program stream is first processed by the front-end decoder/channel decoder 512 to form a program transmission stream conforming to the MPEG-2 standard, which is transferred to the channel buffer 516. This program transmission stream is further transferred to the PID filter 121 for further processing, and the subsequent system is substantially similar to the system in FIG. 1. The terrestrial digital video broadcasting system has no time shift functionality, thus there may be no local storage in the system for storing the normal program.

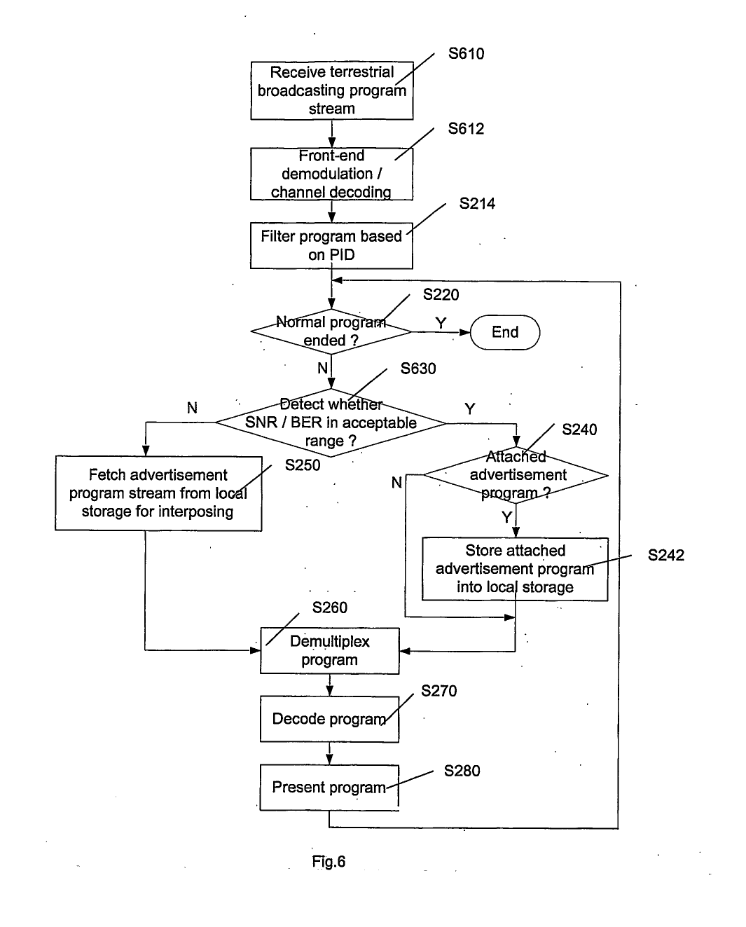

FIG. 6 is a schematic flowchart of interposing prearranged programs during terrestrial digital video broadcasting according to another embodiment of the present invention. This system is substantially the same as the flow shown in FIG. 2, only that the signal sources are different and the flow of receiving program stream is some what different.

The similar portions are no more described, and only the different portions are described in the following.

Firstly, a terrestrial broadcasting program stream is received from the terrestrial broadcast signal (step S610), and it becomes a program transmission stream conforming to the MPEG-2 standard after front-end demodulation and channel decoding (step S612). During front-end demodulation and channel decoding, the bit error ratio (BER) and signal noise ratio (SNR) are calculated. The PID values of the program transmission stream are filtered according to the choice of the user (step S214), and all the transmission small-packets associated with the program chosen by the user are selected for further processing.

Secondly, it is determined whether the broadcasting of the normal program is ended (step S220), for example, the normal program broadcasting can be considered as having been ended if its SNR has been steadily lower than a predetermined value (e.g. 15 dB) for a certain time period (e.g. 5 minutes).

If the broadcasting of the normal program has not been ended, it is further determined whether SNR/BER is within the acceptable range (step S630). If SNR is greater than or equal to a predetermined value, e.g. SNR≧18 dB, then the normal program broadcasting continues; if SNR is less than the predetermined value (18 dB), indicating that the current terrestrial broadcasting signal does not meet certain requirement of broadcasting quality, a prearranged program, i.e. another program, can be acquired from the local storage and interposeed for broadcasting (step S250). Of course, the determination of interposing another program can also be made on the basis of whether BER is less than a predetermined value (e.g. 3.0×10⁻³).

Finally, the normal program or another program is demultiplexed (step S260), further decoded (step S270), and finally presented to the user in certain form (step S280).

There are two main sources of the other program streams stored in the local storage:
1) Other program streams stored in advance in the local storage prior to the broadcasting of the normal program; and
2) During the broadcasting of a normal program, it may be determined that whether a segment is another program attached to the normal program by determining whether the PID value of a transmission small-packet is a specific value, if it is, the segment is stored into a local storage and transmitted for further processing; if not, it is transmitted directly for further processing.

While the present invention has been described with reference to its specific embodiments, it is obvious for those skilled in the art to make many alternations, modifications and variations based on the above description. Therefore, when those alternations, modifications and variations fall into the spirit and scope of the appended claims, they shall be regarded as included in the present invention.

What is claimed is:

1. A method for broadcasting a digital program, comprising:
a. detecting the broadcasting quality of a normal program being broadcast;
b. interposing a prearranged program if the detected broadcasting quality is below a predetermined value, the broadcasting quality of this prearranged program reaching a predetermined level.

2. The method according to claim 1, further comprising:
c. detecting an available broadcasting quality of the normal program when broadcasting the prearranged program;
d. resuming broadcasting the normal program when the available broadcasting quality returns back to another predetermined value.

3. The method according to claim 2, further comprising the step before step d:
e. detecting whether the broadcast of the inserted prearranged program has been finished.

4. The method according to claim 1, wherein said prearranged program is stored in a local storage in advance.

5. The method according to claim 4, wherein said prearranged program comes from another program attached to the normal program being broadcast.

6. The method according to claim 1, further comprising:
g. getting statistics information for time and content type of the inserted prearranged program; said statistics information is used for charge.

7. The method according to claim 1, wherein step b further comprising:
filling a cache used to store other program with the prearranged program if the detected broadcasting quality is below a threshold value, the threshold value being higher than said predetermined value;
wherein obtaining the prearranged program from said cache for broadcasting if the detected broadcasting quality is below a predetermined value.

8. The method according to claim 1, wherein said normal program is transmitted through a network.

9. The method according to claim 8, wherein step (a) comprising: detecting the filling status of the cache used for storing the normal program.

10. The method according to claim 8, wherein said prearranged program coming from a local server which has a specific broadcasting quality.

11. The method according to claim 8, wherein said prearranged program being stored in a local storage in advance, this prearranged program being downloaded from a network.

12. The method according to claim 8, further comprising:
sending a request for requiring a lost segment of the normal program because of the broadcast of the inserted prearranged program;
receiving said lost segment of the normal program; and
combining the lost segment of the normal program with the subsequent normal program for continuously.

13. The method according to claim 12, wherein said combining step comprising:
storing the received lost segment of the normal program in a local storage;
storing the subsequent normal program in a local storage;
reading the received lost segment of the normal program from the stored subsequent normal program in a normal playback order for playing back.

14. A system for broadcasting a digital program, comprising:
a detecting apparatus for detecting the broadcasting quality of a normal program being broadcast;
a switching apparatus for interposing a prearranged program if the detected broadcasting quality is below a predetermined value, the broadcasting quality of this prearranged program reaching a predetermined level.

15. The system according to claim 14, wherein said detecting apparatus being also used to detect the available broadcasting quality of the normal program.

16. The system according to claim 14, wherein said switching apparatus being also used to resume to broadcast the normal program when the detected available broadcasting quality of the normal program returns back to another predetermined value when the prearranged program is being broadcast.

17. The system according to claim 14, further comprising: a statistical apparatus for getting statistics information for time and content type of the inserted prearranged program.

18. The system according to claim 14, wherein said detecting apparatus including a cache controlling apparatus.

19. The system according to claim 14, wherein said switching apparatus including a cache switching apparatus.

20. The system according to claim 14, wherein the normal program is transmitted through a network.
